(19) United States
(12) Patent Application Publication
(10) Pub. No.: US 2006/0039499 A1
(43) Pub. Date: Feb. 23, 2006

(54) Apparatus and method for space-time block coding

(75) Inventors: Chan-Byoung Chae, Seoul (KR); Sung-Ryul Yun, Suwon-si (KR); Hong-Sil Jeong, Seoul (KR); Won-Il Roh, Yongin-si (KR); Dong-Seek Park, Yongin-si (KR); Jae-Yoel Kim, Suwon-si (KR); Jeong-Tae Oh, Yongin-si (KR); Kyun-Byoung Ko, Hwasung-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/204,598

(22) Filed: Aug. 16, 2005

(30) Foreign Application Priority Data
Aug. 17, 2004 (KR) 2004-64846

(51) Int. Cl. H04B 7/02; H04L 1/02

(52) U.S. Cl. 375/299; 375/267

(57) ABSTRACT

A space-time block coding apparatus and method for transmitting an input symbol sequence through a plurality of Tx antennas using a channel information from the receiver in order to improve the performance of a space-time block coding (STFBC). A pre-coder pre-codes an input symbol sequence by multiplying the input symbol sequence by e^{jθ}, θ being a phase rotation angle, the pre-coded symbol sequence being reconstructed to have real and imaginary parts. A grouping mapper forms a grouping pattern based on feedback channel information received from a receiver, and generates a grouping symbol sequence by multiplying the grouping pattern by the pre-coded symbol sequence. A mapper generates symbol vectors by recombining the real and imaginary parts of the grouping symbol sequence in an interleaving scheme. A plurality of Alamouti coders encodes the symbol vectors in an Alamouti scheme and transmits the encoded symbol vectors through corresponding transmit antennas.

### PRIORITY

This application claims priority under 35 U.S.C. § 119 to an application entitled “Apparatus And Method For Space-time Block Coding For Increasing Performance” filed in the Korean Intellectual Property Office on Aug. 17, 2004 and assigned Ser. No. 2004-0064846, the contents of which are incorporated herein by reference.

### BACKGROUND OF THE INVENTION

1. Field of the Invention

The present invention relates generally to a transmit (Tx) antenna diversity apparatus and method in a mobile communication system, and in particular, to a space-time block coding apparatus and method for transmitting an input symbol sequence through a plurality of Tx antennas according to a predetermined method in order to improve the performance of a space-time block coding (STFBC).

2. Description of the Related Art

A fundamental issue in communications is the efficiency and reliability with which data is transmitted on channels. As future-generation multimedia mobile communications require high-speed communication systems capable of transmitting a variety of information including video and wireless data beyond the voice-focused service, it is very significant to increase system efficiency by using a channel coding method suitable for a system.

Generally, a transmission signal in a wireless channel environment of a mobile communication system inevitably experiences loss due to several factors such as multipath interference, shadowing, wave attenuation, time-variant noise, and fading. The information loss causes a severe distortion to the transmission signal, degrading an entire system performance. In order to reduce the information loss, many error control techniques are usually utilized to increase system reliability. A basic error control technique is to use an error correction code.

Additionally, multipath fading is relieved by diversity techniques in the wireless communication system. The diversity techniques are time diversity, frequency diversity, and antenna diversity. Antenna diversity uses multiple antennas and is further branched into receive (Rx) antenna diversity using a plurality of Rx antennas, Tx antenna diversity using a plurality of Tx antennas, and multiple-input multiple-output (MIMO) using a plurality of Tx antennas and a plurality of Rx antennas.

MIMO is a special case of space-time coding (STC) that extends coding of the time domain to the space domain by transmission of a signal encoded in a predetermined coding method through a plurality of Tx antennas, with the intentions of achieving a lower error rate.

V. Tarokh et al. proposed space-time block coding (STBC) as one of methods of efficiently applying antenna diversity (see “Space-Time Block Coding from Orthogonal Designs”, IEEE Trans. On Info., Theory, Vol. 45, pp. 1456-1467, July 1999). The Tarokh STBC scheme is an extension of the transmit antenna diversity scheme of S. M. Alamouti (see, “A Simple Transmit Diversity Technique for Wireless Communications”, IEEE Journal on Selected Area in Communications, Vol. 16, pp. 1451-1458, October 1988), for two or more Tx antennas.

FIG. 1 is a block diagram of a transmitter in a mobile communication system using the conventional Tarokh's STBC scheme. Referring to FIG. 1, the transmitter includes a modulator 100, a serial-to-parallel (S/P) converter 102, an STBC coder 104, and four Tx antennas 106, 108, 110 and 112. The modulator 100 modulates input information data (or coded data) in a predetermined modulation scheme. The modulation scheme can be one of binary phase shift keying (BPSK), quadrature phase shift keying (QPSK), quadrature amplitude modulation (QAM), pulse amplitude modulation (PAM), and phase shift keying (PSK).

The S/P converter 102 parallelizes serial modulation symbols received from the modulator 100, s₁, s₂, s₃, s₄. The STBC coder 104 creates eight symbol combinations by STBC-encoding the four modulation symbols, s₁, s₂, s₃, s₄ and sequentially transmits them through the four Tx antennas 106 to 112. A coding matrix used to generate the eight symbol combinations is expressed as shown in Equation (1),

$${G}_{4} = [ \begin{matrix}{s}_{1} & {s}_{2} & {s}_{3} & {s}_{4} \\ - {s}_{2} & {s}_{1} & - {s}_{4} & {s}_{3} \\ - {s}_{3} & {s}_{4} & {s}_{1} & - {s}_{2} \\ - {s}_{4} & - {s}_{3} & {s}_{2} & {s}_{1} \\ {s}_{1}^{*} & {s}_{2}^{*} & {s}_{3}^{*} & {s}_{4}^{*} \\ - {s}_{2}^{*} & {s}_{1}^{*} & - {s}_{4}^{*} & {s}_{3}^{*} \\ - {s}_{3}^{*} & {s}_{4}^{*} & {s}_{1}^{*} & - {s}_{2}^{*} \\ - {s}_{4}^{*} & - {s}_{3}^{*} & {s}_{2}^{*} & {s}_{1}^{*}\end{matrix} ] \qquad ( 1 )$$

where G₄ denotes the coding matrix for symbols transmitted through the four Tx antennas 106 to 112 and s₁, s₂, s₃, s₄ denote the input four symbols. The number of columns of the coding matrix is equal to that the number of Tx antennas and the number of rows corresponds to the time required to transmit the four symbols. Therefore, the four symbols are transmitted through the four Tx antennas for eight time intervals.

More specifically, for a first time interval, s₁ is transmitted through the first Tx antenna 106, s₂ through the second Tx antenna 108, s₃ through the third Tx antenna 110, and s₄ through the fourth Tx antenna 112. In this manner, −s₄^{*}, −s₃^{*}, s₂^{*}, −s₁^{*} are transmitted through the first to fourth Tx antennas 106 to 112, respectively for an eighth time interval. That is, the STBC coder 104 sequentially provides the symbols of an i^{th} column in the coding matrix to an i^{th} Tx antenna.

As described above, the STBC coder 104 generates eight symbol sequences using the input four symbols, their conjugates and negatives, and transmits them through the four Tx antennas 106 to 112 for eight time intervals. Because the symbol sequences for the respective Tx antennas, that is, the columns of the coding matrix, are mutually orthogonal, as high a diversity gain as a diversity order is achieved.

FIG. 2 is a block diagram of a receiver in the mobile communication system using the conventional STBC scheme. More specifically, the receiver in FIG. 2 is the counterpart of the transmitter illustrated in FIG. 1.

Referring to FIG. 2, the receiver includes a plurality of Rx antennas 200 to 202, a channel estimator 204, a signal combiner 206, a detector 208, a parallel-to-serial (P/S) converter 210, and a demodulator 212. The first to P^{th} Rx antennas 200 to 202 provide signals received from the four Tx antennas of the transmitter illustrated in FIG. 1 to the channel estimator 204 and the signal combiner 206. The channel estimator 204 estimates channel coefficients representing channel gains from the Tx antennas 106 to 112 to the Rx antennas 200 to 202 using the signals received from the first to P^{th} Rx antennas 200 to 202. The signal combiner 206 combines the signals received from the first to P^{th} Rx antennas 200 to 202 with the channel coefficients in a predetermined method. The detector 208 generates hypothesis symbols by multiplying the combined symbols by the channel coefficients, calculates decision statistics for all possible transmitted symbols from the transmitter using the hypothesis symbols, and detects the actual transmitted symbols through threshold detection. The P/S converter 210 serializes the parallel symbols received from the detector 208, and the demodulator 212 demodulates the serial symbol sequence in a predetermined demodulation method, thereby recovering the original information bits.

As described above, the Alamouti STBC technique offers the benefit of achieving as high a diversity order as the number of Tx antennas, namely a full diversity order, without sacrificing data rate by transmitting complex symbols through only two Tx antennas.

The Tarokh STBC scheme, which is extended from the Alamouti STBC scheme, achieves a full diversity order using an STBC in the form of a matrix with orthogonal columns, as described above with reference to FIGS. 1 and 2. However, because four complex symbols are transmitted for eight time intervals, the Tarokh STBC scheme decreases the data rate by half. In addition, because it takes eight time intervals to completely transmit one block with four complex symbols, reception performance is degraded due to channel changes within the block over a fast fading channel. That is, the transmission of complex symbols through four or more Tx antennas requires 2N time intervals for N symbols, causing a longer latency and a decrease in data rate.

To achieve a full rate in a MIMO system that transmits a complex signal through three or more Tx antennas, the Giannakis group presented a full-diversity, full-rate (FDFR) STBC for four Tx antennas using constellation rotation over a complex field.

FIG. 3 is a block diagram of a transmitter in a mobile communication system using a conventional Giannakis STBC scheme. Referring to FIG. 3, the transmitter includes a modulator 300, a pre-coder 302, a space-time mapper 304, and a plurality of Tx antennas 306, 308, 310 and 312. The modulator 300 modulates input information data (or coded data) in a predetermined modulation scheme such as BPSK, QPSK, QAM, PAM or PSK. The pre-coder 302 pre-encodes N, modulation symbols received from the modulator 300, d₁, d₂, d₃, d₄ such that signal rotation occurs in a signal space, and outputs the resulting Nₜ symbols. For notational simplicity, four Tx antennas are assumed. Further, a sequence of four modulation symbols from the modulator 300 is denoted by d. The pre-coder 302 generates a complex vector r by computing the modulation symbol sequence, d using Equation (2),

$$r = Θ d = [ \begin{matrix}1 & {α}_{0}^{1} & {α}_{0}^{2} & {α}_{0}^{3} \\ 1 & {α}_{1}^{1} & {α}_{1}^{2} & {α}_{1}^{3} \\ 1 & {α}_{2}^{1} & {α}_{2}^{2} & {α}_{2}^{3} \\ 1 & {α}_{3}^{1} & {α}_{3}^{2} & {α}_{3}^{3}\end{matrix} ] [ \begin{matrix}{d}_{1} \\ {d}_{2} \\ {d}_{3} \\ {d}_{4}\end{matrix} ] = [ \begin{matrix}{r}_{1} \\ {r}_{2} \\ {r}_{3} \\ {r}_{4}\end{matrix} ] \qquad ( 2 )$$

where Θ denotes a pre-coding matrix. The Giannakis group uses a Vandermonde matrix, which is a unitary, like the pre-coding matrix. In the pre-coding matrix, αᵢ can be expressed as shown in Equation (3).
αᵢ=exp(j2π(i+1/4)/4), i=0,1,2,3 (3)

The Giannakis STBC scheme uses four Tx antennas and is easily extended to more than four Tx antennas, as well. The space-time mapper 304 STBC-encodes the pre-coded symbols using Equation (4),

$$S = [ \begin{matrix}{r}_{1} & 0 & 0 & 0 \\ 0 & {r}_{2} & 0 & 0 \\ 0 & 0 & {r}_{3} & 0 \\ 0 & 0 & 0 & {r}_{4}\end{matrix} ] \qquad ( 4 )$$

where S is a coding matrix for symbols transmitted through the four Tx antennas 306 to 312. The number of columns of the coding matrix is equal to that the number of Tx antennas and the number of rows corresponds to the time required to transmit the four symbols. That is, the four symbols are transmitted through the four Tx antennas for the four time intervals.

More specifically, for a first time interval, r₁ is transmitted through the first Tx antenna 306, with no signals through the other Tx antennas 308, 310, and 312. For a second time interval, r₂ is transmitted through the second Tx antenna 308, with no signals through the other Tx antennas 306, 310, and 312. For a third time interval, r₃ is transmitted through the third Tx antenna 310, with no signals through the other Tx antennas 306, 308, and 312. For a fourth time interval, r₄ is transmitted through the fourth Tx antenna 310, with no signals through the other Tx antennas 306, 308, and 310.

Upon receipt of the four symbols on a radio channel for the four time intervals, a receiver (not shown) recovers the modulation symbol sequence d by maximum likelihood (ML) decoding.

In 2003, Tae-Jin Jung and Kyung-Whoon Cheun proposed a pre-coder and a concatenated code with an excellent coding gain, when compared to the Giannakis STBC. In their work, they enhance the coding gain by concatenating Alamouti STBCs, instead of using a diagonal matrix proposed by the Giannakis group. Herein, their STBC will be called an “Alamouti FDFR STBC”.

FIG. 4 is a block diagram of a transmitter in a mobile communication system using a conventional Alamouti FDFR STBC for four Tx antennas. Referring to FIG. 4, the transmitter includes a pre-coder 400, a mapper 402, a delay 404, two Alamouti coders 406 and 408, and four Tx antennas 410, 412, 414, and 416. The pre-coder 400 pre-encodes input four modulation symbols, d₁, d₂, d₃, d₄ such that signal rotation occurs in a signal space. For the input of a sequence of the four modulation symbols, d, the pre-coder 400 generates a complex vector r using Equation (5),

$$r = Θ d = [ \begin{matrix}1 & {α}_{0}^{1} & {α}_{0}^{2} & {α}_{0}^{3} \\ 1 & {α}_{1}^{1} & {α}_{1}^{2} & {α}_{1}^{3} \\ 1 & {α}_{2}^{1} & {α}_{2}^{2} & {α}_{2}^{3} \\ 1 & {α}_{3}^{1} & {α}_{3}^{2} & {α}_{3}^{3}\end{matrix} ] [ \begin{matrix}{d}_{1} \\ {d}_{2} \\ {d}_{3} \\ {d}_{4}\end{matrix} ] = [ \begin{matrix}{r}_{1} \\ {r}_{2} \\ {r}_{3} \\ {r}_{4}\end{matrix} ] \qquad ( 5 )$$

where αᵢ=exp(j2π(i+1/4)/4), i=0,1,2,3.

The mapper 402 groups the four pre-coded symbols by twos and outputs two vectors, each including two elements, [r₁, r₂]^{T} and [r₃, r₄]^{T} to the Alamouti coder 406 and the delay 404, respectively.

The delay 404 delays the second vector [r₃, r₄]^{T} for one time interval. Accordingly, the first vector [r₁, r₂]^{T} is provided to the Alamouti coder 406 in a first time interval and the second vector [r₃, r₄]^{T} is provided to the Alamouti coder 408 in a second time interval. The Alamouti coder refers to a coder that operates in the Alamouti STBC scheme.

The Alamouti coder 406 encodes [r₁, r₂]^{T} so that it is transmitted through the first and second Tx antennas 410 and 412 for first and second time intervals. The Alamouti coder 408 encodes [r₃, r₄]^{T} so that it is transmitted through the third and fourth Tx antennas 414 and 416 for third and fourth time intervals. A coding matrix used to transmit the four symbols from the mapper 402 through the multiple antennas is shown in Equation (6).

$$S = [ \begin{matrix}{r}_{1} & {r}_{2} & 0 & 0 \\ - {r}_{2}^{*} & {r}_{1}^{*} & 0 & 0 \\ 0 & 0 & {r}_{3} & {r}_{4} \\ 0 & 0 & - {r}_{4}^{*} & {r}_{3}^{*}\end{matrix} ] \qquad ( 6 )$$

Unlike the coding matrix illustrated in Equation (4), the coding matrix in Equation (6) is designed to be an Alamouti STBC rather than a diagonal matrix. The use of the Alamouti STBC scheme increases a coding gain.

This Alamouti FDFR STBC, however, has the distinctive shortcoming of increased coding complexity because the transmitter needs to perform computations between all elements of the pre-coding matrix and an input vector, for pre-coding. For example, for four Tx antennas, because 0 is not included in the elements of the pre-coding matrix, computations must be performed on 16 elements. Also, the receiver needs to perform ML decoding with a large volume of computation in order to decode the signal d transmitted by the transmitter.

To reduce such high complexity, Chan-Byoung Chae et al. of Samsung Electronics proposed a novel STBC, which is shown below in Equation (7).

$$Θ = [ \begin{matrix}1 & {α}_{0}^{1} & ⋯ & {α}_{0}^{{N}_{t} / 2 - 1} & 0 & ⋯ & 0 \\ 0 & 0 & ⋯ & 0 & 1 & ⋯ & {α}_{1}^{{N}_{t} / 2 - 1} \\ ⋮ & ⋮ & ⋰ & ⋯ & ⋯ & ⋰ & ⋮ \\ 1 & {α}_{{N}_{t} - 2}^{1} & ⋯ & {α}_{{N}_{t} - 2}^{{N}_{t} / 2 - 1} & 0 & ⋯ & 0 \\ 0 & 0 & ⋯ & 0 & 1 & ⋯ & {α}_{{N}_{t} - 1}^{{N}_{t} / 2 - 1}\end{matrix} ] \qquad ( 7 )$$

In Equation (7), Θ is a pre-coding matrix for an arbitrary even number of Tx antennas. The subsequent operations are performed in the same manner as done in Cheun's group. However, compared to the FDFR Alamouti STBC scheme, Chae's scheme is remarkably reduces ML (Maximum Likelihood) decoding complexity at the receiver through a series of operations, that is, puncturing and shifting.

However, all the approaches described above suffer from high decoding complexity relative to the Alamouti scheme that allows linear decoding of transmitted symbols, and thus continual efforts have been made to further decrease the decoding complexity.

In this context, Professor Sundar Rajan's group (hereinafter, referred to as Sundar Rajan group) presented an FDFR STBC that enables linear decoding. For the Sundar Rajan group's STBC, every value rᵢ of the coding matrix illustrated in Equation (6) is multiplied by e^{jθ} (i.e., rotation on a complex plane), and the real and imaginary parts of the resulting new value xᵢ+jyᵢ are reconstructed. The coding matrix produced in this way is expressed in Equation (8).

$$S = [ \begin{matrix}{x}_{1} + {jy}_{3} & {x}_{2} + {jy}_{4} & 0 & 0 \\ - {( {x}_{2} + {jy}_{4} )}^{*} & {( {x}_{1} + {jy}_{3} )}^{*} & 0 & 0 \\ 0 & 0 & {x}_{3} + {jy}_{1} & {x}_{4} + {jy}_{2} \\ 0 & 0 & - {( {x}_{4} + {jy}_{2} )}^{*} & {( {x}_{3} + {jy}_{1} )}^{*}\end{matrix} ] \qquad ( 8 )$$

In Equation (8), xᵢ+jyᵢ is value, which is a product of input information symbols multiplied by do (i.e., rotation on a complex plane).

The use of Equation (8) enables linear decoding at the receiver, thereby decreasing decoding complexity. Professor Sundar Rajan uses a fixed phase rotation angle θ. Here, θ=(1/2)atan2.

A mobile communication system using the Sundar Rajan group's STBC scheme adopts a transmitter having the configuration illustrated in FIG. 5. Information symbols s₁, s₂, s₃, s₄ are multiplied by exp(jθ) in a pre-coder and then reconstructed in a mapper. More specifically, the mapper reconstructs pre-coded symbols cᵢ=xᵢ+jyᵢ to c₁′=x₁+jy₃, c₂′=x₂+jy₄, c₃′=x₃+jy₁, and c₄′+x₄+jy₂, and groups the reconstructed symbols in pairs to vectors [c₂′c₁′] and [c₄′c₃′]. The vectors [c₂′c₁′] and [c₄′c₃′] are transmitted through their corresponding Alamouti coders.

To show that the performance of the Sundar Rajan group's STBC can be further improved, a brief survey of an orthonormal space-time code and orthogonal space-time code will be given below.

To demodulate an orthonormal space-time code S proposed by Tarokh et. al., S is multiplied by its Hermitian, S^{H}. This operation can be expressed in Equation (9),

$${SS}^{H} = [ \begin{matrix}ρ & 0 & 0 & 0 \\ 0 & ρ & 0 & 0 \\ 0 & 0 & ρ & 0 \\ 0 & 0 & 0 & ρ\end{matrix} ] \qquad ( 9 )$$

where ρ is a constant. If a space-time code satisfies Equation (9), it was found out that an available full rate can be expressed as shown in Equation (10).

$${R}_{max} = \frac{a + 1}{{2}^{a}} \qquad ( 10 )$$

The number of Tx antennas N=2^{a}. Therefore, for a system with four Tx antennas, a=2 and Rₘₐₓ=3/4.

The Sundar Rajan group proved that its orthogonal space-time code also achieves full diversity. This full diversity can be shown using Equation (11),

$${SS}^{H} = [ \begin{matrix}{ρ}_{1} & 0 & 0 & 0 \\ 0 & {ρ}_{1} & 0 & 0 \\ 0 & 0 & {ρ}_{2} & 0 \\ 0 & 0 & 0 & {ρ}_{2}\end{matrix} ] \qquad ( 11 )$$

where ρ₁=|h₁|²+|h₂|² and ρ₂=|h₃|²+|h₄|² (h is a channel coefficient). One thing to be noted here is that the user of this orthogonal space-time code leads to the rate as shown in Equation (12).

$${R}_{max} = \frac{2 a}{{2}^{a}} \qquad ( 12 )$$

More specifically, Equation (12) shows that Rₘₐₓ=1 can be achieved for a system with four Tx antennas because N=2^{a}. That is, the use of an orthogonal space-time code achieves full diversity and full rate.

As can be seen from the description above, the orthonormal space-time code cannot achieve full diversity full rate, and the orthogonal space-time code can achieve full diversity full rate. However, performance of the orthonormal space-time code is an upperbound as far as performance is concerned. Therefore, the performance of the orthogonal space-time code must be improved for application.

### SUMMARY OF THE INVENTION

Accordingly, the present invention has been designed to substantially solve at least the above problems and/or disadvantages and to provide at least the advantages below. An object of the present invention is to provide a space-time block coding apparatus and method for improving performance in a mobile communication system with a plurality of antennas.

Another object of the present invention is to provide a space-time block coding apparatus and method for improving performance in a mobile communication system with a plurality of antennas, wherein vector symbols are rotated on a complex plane and the real and imaginary parts of the resulting new symbols xᵢ+jyᵢ are reconstructed, prior to transmission.

A further object of the present invention is to provide a space-time block coding apparatus and method for improving performance by providing a shuffling mapper in a mobile communication system using multiple antennas, wherein vector symbols are rotated on a complex plane and the real and imaginary parts of the resulting new symbols xᵢ+jyᵢ are reconstructed, prior to transmission.

According to one aspect of the present invention, in a transmitter with a plurality of transmit antennas in a communication system using a space-time block coding scheme, a pre-coder pre-codes an input symbol sequence by multiplying the input symbol sequence by e^{jθ}, θ being a phase rotation angle, the pre-coded symbol sequence being reconstructed to have real and imaginary parts. A grouping mapper forms a grouping pattern based on feedback channel information received from a receiver, and generates a grouping symbol sequence by multiplying the grouping pattern by the pre-coded symbol sequence. A mapper generates symbol vectors by recombining the real and imaginary parts of the grouping symbol sequence in an interleaving scheme. A plurality of Alamouti coders encodes the symbol vectors in an Alamouti scheme and transmits the encoded symbol vectors through corresponding transmit antennas.

According to another aspect of the present invention, in a receiver with a plurality of receive antennas in a system using a space-time block coding scheme, a channel estimator estimates channel coefficients by using a signal received through a receive antenna. A feedback transmitter transmits the channel coefficient or grouping pattern representing channel information from the channel estimator to a grouping mapper of a transmitter.

According to yet another aspect of the present invention, in a space-time block coding method in a transmitter with a plurality of transmit antennas, an input symbol sequence is pre-coded by multiplying the input symbol sequence by e^{jθ}, θ being a phase rotation angle, the pre-coded symbol sequence being reconstructed to have real and imaginary parts. A grouping pattern is formed based on feedback channel information received from a receiver, and a grouping symbol sequence is generated by multiplying the grouping pattern by the pre-coded symbol sequence. Symbol vectors are generated by recombining the real and imaginary parts of the grouping symbol sequence in an interleaving scheme. The symbol vectors are encoded in an Alamouti scheme and the encoded symbol vectors are transmitted through corresponding transmit antennas.

According to a further another aspect of the present invention, in a receiving method of a receiver with a plurality of receive antennas in a system using a space-time block coding scheme, channel coefficients are estimated using a signal received through a receive antenna. The channel coefficient or grouping pattern representing channel information is transmitted to a grouping mapper of a transmitter.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a transmitter in a mobile communication system using a conventional STBC scheme;

FIG. 2 is a block diagram of a receiver in the mobile communication system using the conventional STBC scheme;

FIG. 3 is a block diagram of a transmitter in a mobile communication system using a conventional Giannakis STBC scheme;

FIG. 4 is a block diagram of a transmitter in a mobile communication system using a conventional Alamouti FDFR STBC scheme with four Tx antennas proposed by Tae-Jin Jung and Kyung-Whoon Cheun;

FIG. 5 is a block diagram of a transmitter in a mobile communication system using a Sundar Rajan group's STBC scheme;

FIG. 6 is a block diagram of a transmitter in a mobile communication system using an STBC scheme according to the present invention;

FIG. 7 is a block diagram of a receiver in the mobile communication system using an STBC scheme according to the present invention;

FIG. 8 is a flowchart illustrating a transmission operation of a transmitter in a mobile communication system using an STBC scheme according to the present invention;

FIG. 9 is a flowchart illustrating a reception operation of a receiver in a mobile communication system using an STBC scheme according to the present invention; and

FIG. 10 is a performance analysis graph illustrating a bit error rate (BER) of a mobile communication system using an STBC scheme according to the present invention.

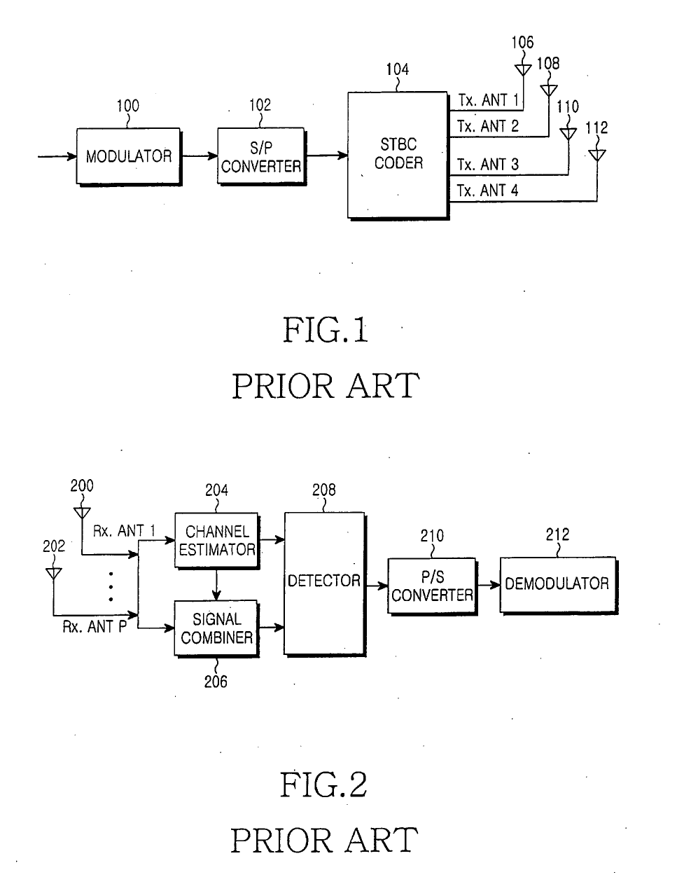

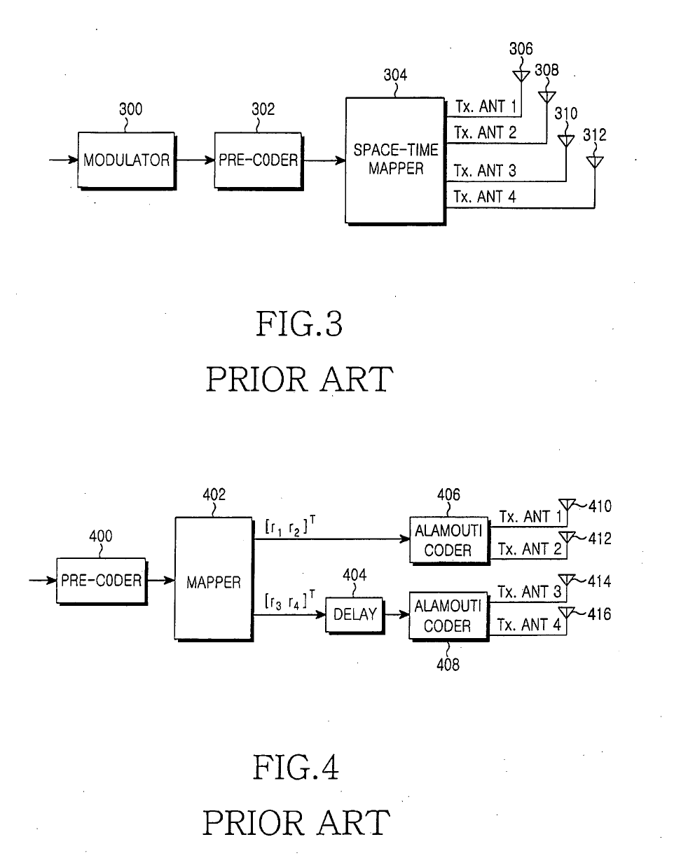

### DETAILED DESCRIPTION OF THE PREFERRED EMBODIMENTS

Preferred embodiments of the present invention will be described in detail herein below with reference to the accompanying drawings. In the following description, well-known functions or constructions are not described in detail since they would obscure the invention in unnecessary detail.

Generally, the present invention provides a grouping mapper (or a shuffling mapper) for improving performance in a system using an FDFR (Full Diversity Full Rate) orthogonal STBC. In addition, the present invention can be applied to a non FDFR space-time block coding (STBC) scheme. Non FDFR STBC scheme groups input symbols without rotation on a complex plane.

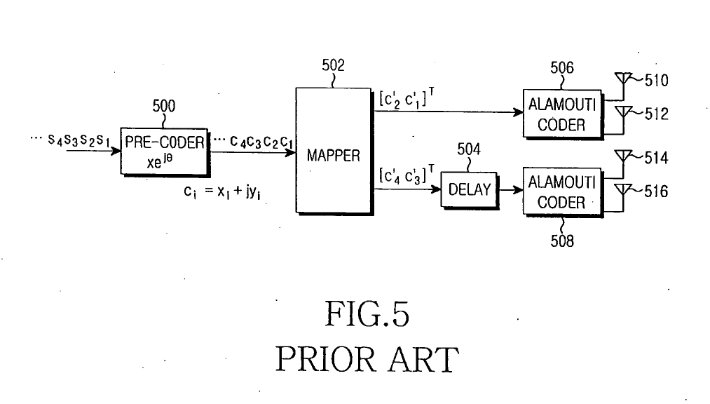

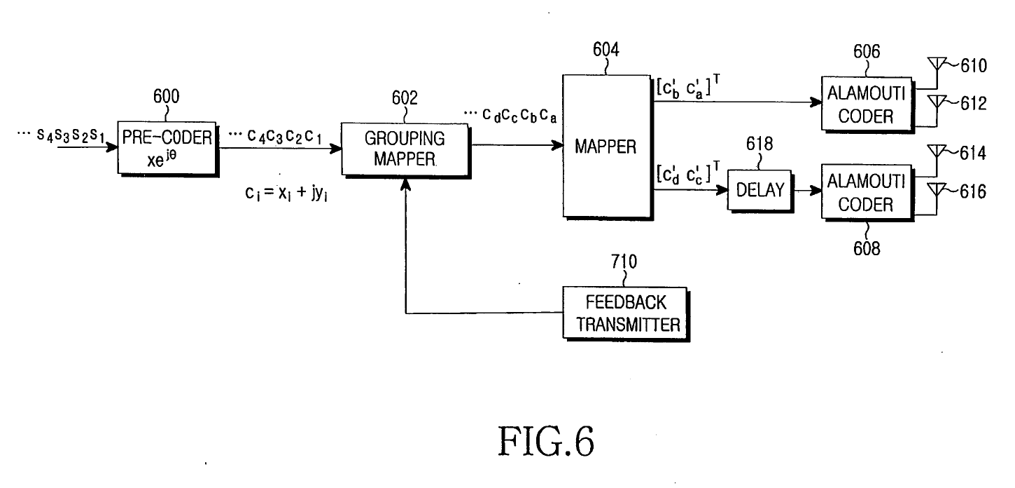

FIG. 6 is a block diagram of a transmitter in a mobile communication system using an STBC scheme according to the present invention. Referring to FIG. 6, a pre-coder 600 multiplies each of input information symbols s₁, s₂, s₃, s₄ by e^{jθ}, that is, rotates s₁, s₂, s₃, s₄ on a complex plane by θ, resulting in new symbols c₁, c₂, c₃, c₄ expressed as xᵢ+jyᵢ. A grouping mapper (or a shuffling mapper) 602 groups the symbols c₁, c₂, c₃, c₄ by using feedback information from a receiver. A mapper 604 reconstructs the grouped symbols cₐ, c_{b}, c_{c}, and groups the reconstructed symbols cₐ, c_{b}, c_{c} in pairs to vectors [c_{b}′cₐ′]^{T} and [c_{d}′c_{c}′]^{T}. The vectors [c_{b}′cₐ′]^{T} and [c_{d}′c_{c}′]^{T} are transmitted to their corresponding Alamouti coders 606 and 608. The transmitting operation through Alamouti coder and antennas is equal to that of FIG. 5. The grouping mapper (or the shuffling mapper) 602 and the mapper 604 can be incorporated into a single mapper. The single mapper refers to a grouping mapper.

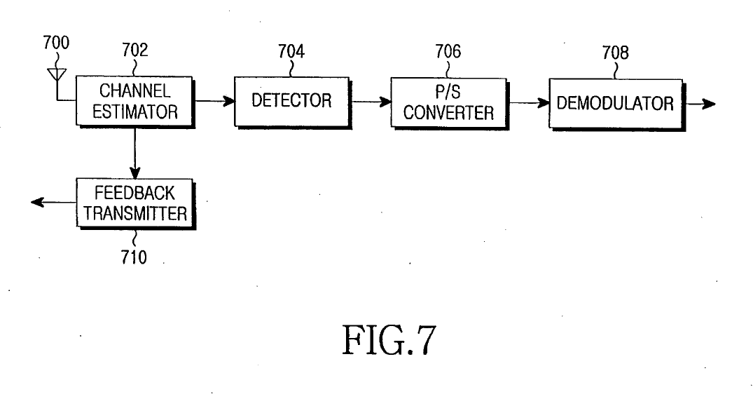

FIG. 7 is a block diagram of a receiver in the mobile communication system using the STBC scheme according to the present invention. For notational simplicity, the receiver is assumed to have one Rx antenna.

Referring to FIG. 7, a channel estimator 702 performs channel estimation on a signal received through an Rx antenna 700. After the channel estimation, the received signal is decoded in a predetermined decoding method. A feedback transmitter 710 transmits channel coefficients received from the channel estimator 702 to the grouping mapper 602 of the transmitter. The operation of the feedback transmitter 710 will be detailed below.

In accordance with the present invention, the receiver feeds back the channel coefficients of all channels to the transmitter or transmits a new grouping pattern pair index.

1) Feedback of All Channel Information form the Receiver

Upon receipt of the channel coefficients estimated at the receiver, the grouping mapper 602 utilizes Equation (13),
arg min|ρ₁−ρ₂| (13)
where ρ₁=|hᵢ|²+|hⱼ|² and ρ₁=|hₘ|+|hₙ|², and i, j, m, and n denote arbitrary values and h are channel coefficients representing channels between the Tx antenna and the Rx antenna, respectively. When the transmitter uses four Tx antennas and the receiver uses one Rx antenna, h₁, h₂, h₃, and h₄ are the channel coefficients representing channel information between the Tx antennas to the Rx antenna. When the grouping mapper receives channel values of the channels h₁, h₂, h₃, and h₄ from the receiver, the grouping mapper groups pairs (i, j) and (m, n) satisfying Equation. (13) with respect to the pre-coded information symbols and transmits them to the mapper 604.

2) Transmission of New Grouping Pattern from the Receiver

Because it is not practical for the receiver to feed back all received channels to the transmitter, the receiver feeds back a grouping pattern computed by Equation. (13) to the grouping mapper 602 of the transmitter. The grouping mapper 602 performs a grouping by using the grouping pattern. The grouping pattern computed in the receiver may be a grouping pattern index indicating a grouping pattern corresponding to the grouping pattern index.

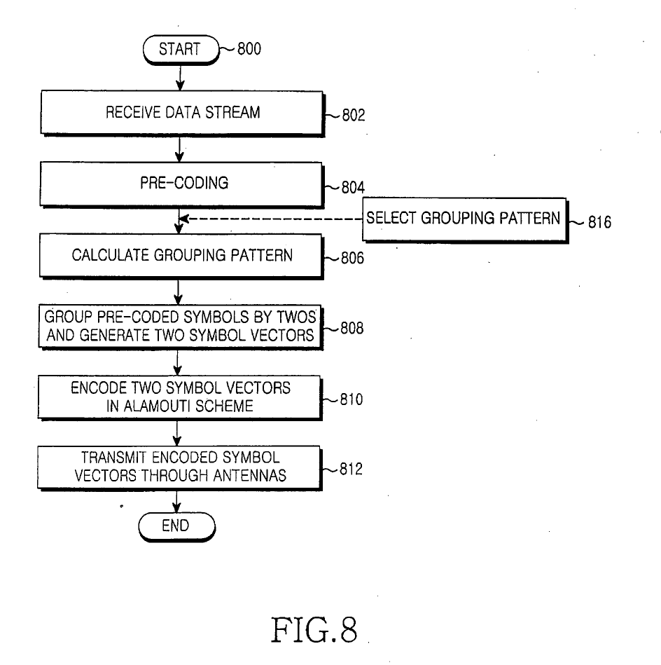

FIG. 8 is a flowchart illustrating a transmission operation of a transmitter in a mobile communication system using the STBC scheme according to the present invention. Referring to FIG. 8, upon receipt of a data stream s₁, s₂, s₃, s₄ in step 802, the pre-coder pre-codes the data stream in step 804. That is, the pre-coder multiplies the data stream s₁, s₂, s₃, s₄ by exp(jθ), and outputs the pre-coded symbols c₁, c₂, c₃, c₄ (c₁=x₁+jy₃, c₂=x₂+jy₄, c₃=x₃+jy₁, and c₄=x₄+jy₂). The transmitter calculates a grouping pattern based on the channel coefficients received from the receiver by Equation (13) in step 806, or selects a grouping pattern according to a grouping pattern index received from the receiver in step 816. The mapper multiplies the selected grouping pattern by the pre-coded symbols maps, groups the symbols by twos, and outputs two symbol vectors in step 808. The two symbol vectors are encoded in the Alamouti scheme in step 810 and are transmitted through their corresponding Tx antennas in step 812.

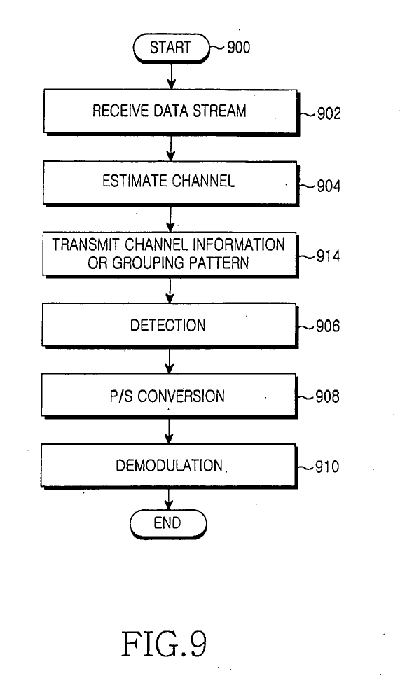

FIG. 9 is a flowchart illustrating a reception operation of a receiver in a mobile communication system using the STBC scheme according to the present invention. Referring to FIG. 9, upon receipt of a data stream from the transmitter in step 902, the data stream is channel-estimated in step 904, and the channel coefficients are transmitted as channel information to the transmitter in step 914. The transmitter calculates a grouping pattern using Equation (13). Alternatively, the receiver can calculate a grouping pattern by Equation (13) rather than transmitting the channel coefficients to the transmitter, and transmits its index to the transmitter, if this is preset in the system.

When the transmitter directly calculates the grouping pattern using the channel information received from the receiver, the transmitter notifies the receiver of the grouping pattern index in order to increase communication accuracy. When the transmitter's index is different from the receiver's index, the transmission of the index of the transmitter's selected grouping pattern on a common channel to the receiver renders data transmission between them more accurate. Thereafter, detection in step 906, P/S conversion in step 908, and demodulation in step 910 are performed in the same manner as in existing systems.

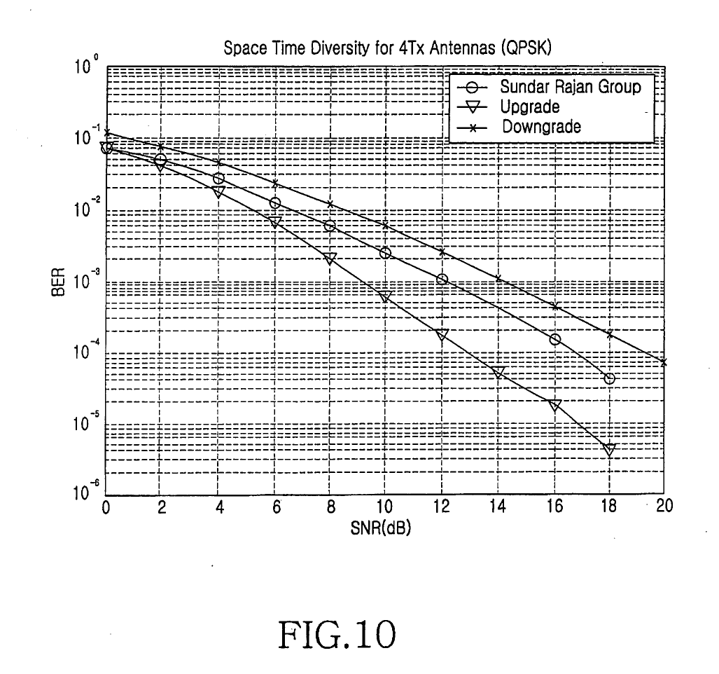

FIG. 10 is a performance analysis graph illustrating a bit error rate (BER) of a mobile communication system using the STBC scheme according to the present invention. Referring to FIG. 10, a gain is improved more than 3 dB in 10⁻³ BER when compared to the Sundar Rajan group's STBC scheme. The performance of the system according to the present invention is indicated by ∇-curve, while the performance of the system using the Sundar Rajan group's STBC scheme is indicated by ∘-curve. That is, an antenna set having the smallest difference between the values of ρ₁ and ρ₂ is illustrated in FIG. 10. On the contrary, ×-curve represents an antenna set having the largest difference between the values of ρ₁ and ρ₂. As shown in FIG. 10, the system according to the present invention has the best performance.

In addition to the FDFR STFBC, the present invention can be applied to a partial orthogonal STBC as illustrated in Equation (14),

$$S = [ \begin{matrix}{r}_{1} & {r}_{2} & 0 & 0 \\ - {r}_{2}^{*} & {r}_{1}^{*} & 0 & 0 \\ 0 & 0 & {r}_{3} & {r}_{4} \\ 0 & 0 & - {r}_{4}^{*} & {r}_{3}^{*}\end{matrix} ] \qquad ( 14 )$$

where r, which is different from r in Equation (6), denotes a real input data stream that does not pass through the pre-coder. In this case, diversity has 2 instead of 4. The system using Equation (14) performs an antenna grouping by Equation (13) in order to improve system performance. That is, the transmission of the symbol sequence grouped based on channel information received from the receiver can be applied the FDFR STBC and other STBCs.

For better understanding of the present invention, a real system will be taken as an example. In an Orthogonal Frequency Division Multiple Access (OFDMA) system based on IEEE 802.16, the receiver calculates the average channel value of every subchannel including N subcarriers in order to reduce the amount of feedback information. The transmitter calculates a grouping pattern based on the average channel values of the subchannels. The transmitter then notifies the receiver of the selected grouping pattern. This bidirectional communication ensures communication accuracy.

As described above, in a space-time block coding apparatus for transmitting an input symbol sequence through a plurality of Tx antennas in a predetermined method in a transmitter of a communication system according to the present invention, feedback channel information transmitted to a receiver is used and a grouping mapper is provided to a transmitter, thereby increasing STBC performance.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A transmitter in a communication system using a space-time block coding scheme, the transmitter comprising:
a pre-coder for pre-coding an input symbol sequence;
a grouping mapper for forming a grouping pattern based on feedback channel information received from a receiver, and generating a grouping symbol sequence by multiplying the grouping pattern by the pre-coded symbol sequence; and
a plurality of antennas corresponding to the group symbol sequence, for transmitting the grouping symbol sequence received from the grouping mapper.

2. The transmitter of claim 1, wherein the grouping mapper forms the grouping pattern based on the feedback channel information using:
arg min |ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing the feedback channel information between the plurality of transmit antennas and receive antennas.

3. The transmitter of claim 1, wherein the formed grouping pattern is transmitted to the receiver on a common channel.

4. A transmitter in a communication system using a space-time block coding scheme, the transmitter comprising:
a pre-coder for pre-coding an input symbol sequence;
a grouping mapper for generating a grouping symbol sequence by multiplying a grouping pattern received from a receiver by the pre-coded symbol sequence received from the pre-coder; and
a plurality of antennas corresponding to the group symbol sequence, for transmitting the grouping symbol sequence received from the grouping mapper.

5. The transmitter of claim 4, wherein the receiver calculates the grouping pattern using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing channel information between the plurality of transmit antennas and receive antennas.

6. The transmitter of claim 4, wherein the grouping pattern received from the receiver is a grouping pattern index.

7. A method of space-time block coding in a transmitter having a plurality of transmit antennas, the method comprising the steps of:
pre-coding an input symbol sequence;
forming a grouping pattern based on feedback channel information received from a receiver;
generating a grouping symbol sequence by multiplying the grouping pattern by the pre-coded symbol sequence; and
transmitting the grouping symbol sequence through at least one of the plurality of antennas corresponding to the group symbol sequence.

8. The space-time block coding method of claim 7, wherein the grouping pattern is formed using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing the feedback channel information between the plurality of transmit antennas and receive antennas.

9. The space-time block coding method of claim 7, further comprising the step of transmitting the grouping pattern selected by the transmitter to the receiver on a common channel.

10. A method of space-time block coding in a transmitter having a plurality of transmit antennas, the method comprising the steps of:
pre-coding an input symbol sequence;
generating a grouping symbol sequence by multiplying a grouping pattern received from a receiver by the pre-coded symbol sequence; and
transmitting the grouping symbol sequence through at least one of the plurality of antennas corresponding to the group symbol sequence.

11. The space-time block coding method of claim 10, wherein the grouping pattern received from the receiver is calculated using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing channel information between the plurality of transmit antennas and receive antennas.

12. The space-time block coding method of claim 10, wherein the grouping pattern received from the receiver is a grouping pattern index.

13. A transmitter having a plurality of transmit antennas in a communication system using a space-time block coding scheme, the transmitter comprising:
a pre-coder for pre-coding an input symbol sequence by multiplying the input symbol sequence by e^{jθ}, θ being a phase rotation angle, the pre-coded symbol sequence being reconstructed to have real and imaginary parts;
a grouping mapper for forming a grouping pattern based on feedback channel information received from a receiver, and generating a grouping symbol sequence by multiplying the grouping pattern by the pre-coded symbol sequence;
a mapper for generating symbol vectors by recombining the real and imaginary parts of the grouping symbol sequence using an interleaving scheme; and
a plurality of Alamouti coders for encoding the symbol vectors in an Alamouti scheme and transmitting the encoded symbol vectors through at least one of the plurality of transmit antennas corresponding to the grouping symbol sequence.

14. The transmitter of claim 13, wherein the grouping mapper forms the grouping pattern based on the feedback channel information using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing the feedback channel information between the plurality of transmit antennas and receive antennas.

15. The transmitter of claim 13, wherein an i^{th} coder of the plurality of Alamouti coders encodes an i^{th} symbol vector using the Alamouti scheme and transmits the encoded symbol vector through (2i−1)^{th} and 2i^{th} antennas in (2i−1)^{th} and 2i^{th} time intervals.

16. A transmitter having a plurality of transmit antennas in a communication system using a space-time block coding scheme, the transmitter comprising:
a pre-coder for pre-coding an input symbol sequence by multiplying the input symbol sequence by e^{jθ}, θ being a phase rotation angle, the pre-coded symbol sequence being reconstructed to have real and imaginary parts;
a grouping mapper for generating a grouping symbol sequence by multiplexing a grouping pattern received from a receiver by the pre-coded symbol sequence received from the pre-coder;
a mapper for generating symbol vectors by recombining the real and imaginary parts of the grouping symbol sequence using an interleaving scheme; and
a plurality of Alamouti coders for encoding the symbol vectors using an Alamouti scheme and transmitting the encoded symbol vectors through at least one of the plurality of transmit antennas corresponding to the grouping symbol sequence.

17. The transmitter of claim 16, wherein the grouping pattern received from the receiver is calculated in the receiver using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing channel information between the plurality of transmit antennas and receive antennas.

18. The transmitter of claim 16, wherein the grouping pattern received from the receiver is a grouping pattern index.

19. A receiver having a plurality of receive antennas in a communication system using a space-time block coding scheme, comprising:
a channel estimator for estimating channel coefficients using a signal received through at least one of the plurality of receive antennas; and
a feedback transmitter for transmitting one of the channel coefficient and a grouping pattern representing channel information, from the channel estimator to a grouping mapper of a transmitter.

20. The receiver of claim 19, wherein the grouping pattern is calculated using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing channel information between transmit antennas and receive antennas.

21. A method of space-time block coding in a transmitter having a plurality of transmit antennas, comprising the steps of:
pre-coding an input symbol sequence by multiplying the input symbol sequence by e^{jθ}, θ being a phase rotation angle, the pre-coded symbol sequence being reconstructed to have real and imaginary parts;
forming a grouping pattern based on feedback channel information received from a receiver;
generating a grouping symbol sequence by multiplying the grouping pattern by the pre-coded symbol sequence;
generating symbol vectors by recombining the real and imaginary parts of the grouping symbol sequence using an interleaving scheme;
encoding the symbol vectors using an Alamouti scheme; and
transmitting the encoded symbol vectors through at least one of the plurality of transmit antennas corresponding to the grouping symbol sequence.

22. A method of space-time block coding in a transmitter having a plurality of transmit antennas, comprising the steps of:
pre-coding an input symbol sequence by multiplying the input symbol sequence by e^{jθ}, θ being a phase rotation angle, the pre-coded symbol sequence being reconstructed to have real and imaginary parts;
generating a grouping symbol sequence by multiplexing a grouping pattern received from a receiver by the pre-coded symbol sequence;
generating symbol vectors by recombining the real and imaginary parts of the grouping symbol sequence using an interleaving scheme;
encoding the symbol vectors using an Alamouti scheme; and
transmitting the encoded symbol vectors through at least one of the plurality of transmit antennas corresponding to the grouping symbol sequence.

23. A method of receiving in a receiver having a plurality of receive antennas in a system using a space-time block coding scheme, comprising the steps of:
estimating channel coefficients using a signal received through at least one of the plurality of receive antennas; and
transmitting one of the channel coefficient and a grouping pattern representing channel information to a grouping mapper of a transmitter.

24. The receiving method of claim 23, wherein the grouping pattern is calculated using:
arg min|ρ₁−ρ₂|

where ρ₁=|hᵢ|²+|hⱼ|² and ρ₂=|hₘ|²+|hₙ|², and hᵢ, hⱼ, hₘ, and hₙ are channel coefficients representing the channel information between transmit antennas and receive antennas.
